(19) United States
(12) Patent Application Publication
(10) Pub. No.: US 2022/0390081 A1
(43) Pub. Date: Dec. 8, 2022

(54) VEHICLE LAMP MODULE AND VEHICLE LAMP

(71) Applicant: HASCO VISION TECHNOLOGY CO., LTD., Shanghai (CN)

(72) Inventor: Jie ZHANG, Shanghai (CN)

(73) Assignee: HASCO VISION TECHNOLOGY CO., LTD., Shanghai (CN)

(21) Appl. No.: 17/776,838

(22) PCT Filed: Mar. 24, 2020
(86) PCT No.: PCT/CN2020/080903

§ 371 Date: May 13, 2022

(30) Foreign Application Priority Data
Dec. 4, 2019 (CN) 201911228170.4

(51) Int. Cl. F21S 41/663; F21S 41/147; F21S 41/43; F21S 41/27; F21S 41/32; F21S 41/36

(52) U.S. Cl. CPC F21S 41/663; F21S 41/147; F21S 41/43; F21S 41/27; F21S 41/321; F21S 41/36; F21W 2102/13

(57) ABSTRACT

The present invention relates to a vehicle lamp module comprising a lens, a shading plate with a cut-off line structure, a low beam module, and a high beam module. Light emitted by the low beam module is suitable for interception by the shading plate and then emission to the lens to form a low beam type. Light emitted by the high beam module is suitable for interception by the shading plate and then emission to the lens to form a main high beam type located above a light and shade cut-off line. The vehicle lamp module further comprises an auxiliary high beam module. Light emitted by the auxiliary high beam module is suitable for interception by the shading plate and then emission to the lens to form an auxiliary high beam type located below the light and shade cut-off. The vehicle lamp module provides high beam with more uniform brightness.

### FIELD

The present disclosure relates to a vehicle lighting device, in particular to a vehicle lamp module. In addition, the present disclosure further relates to a vehicle lamp.

### BACKGROUND

Vehicle headlamps include high beams and low beams, the effective lighting distance of the low beams should be 50 meters, the effective lighting distance of the high beams should be 150 meters, and the high beam and the low beam are switched to illuminate a road in front of a vehicle. The high beam has a high angle and a long distance, thus the line of sight can be improved and the observation field of view can be broadened; the low beam has a low angle and short distance, thus dazzling cannot be caused to a driver of an opposite vehicle. During meeting of the vehicles, if a user turns on high beams on his/her vehicle, a driver of a vehicle opposite to the user's vehicle cannot clearly see the road surface due to bright light and cannot judge the accurate position of the user's vehicle, which will increase the probability of accidents.

In the prior art, a low beam type may be formed by a conventional shading plate. Divergent light emitted by the light source is reflected by a reflection cup and then converged near a perifocus of the reflection cup, forms a light and shade cut-off line after being shielded by the shading plate and is imaged to a road surface through a collimating lens, and a high beam type is formed after the shading plate is moved away through a driving mechanism. In order to simplify the structure, many vehicle lamp structures capable of switching high and low beam types without moving the shading plate have been provided. The Chinese disclosure patent with the application date of Aug. 31, 2016 and the application number of 201610773448.6 discloses a brand-new LED high beam and low beam integrated headlamp projection lamp wick. When the LED high beam and low beam integrated headlamp projection lamp wick needs to emit low beam light, the low beam light can be emitted by turning on an upper light source of an LED light source, and high beam light can be emitted by turning on the upper light source and a lower light source of the LED light source at the same time. However, in such a structure, a shading plate is not switched, the high beam is formed by superposing and combining the low beam light and the high beam light, and the high beam light for combining the high beam has obviously higher brightness, so that an obvious brightness gradient can be seen in the combined high beam, and certain interference is caused to a driver.

Aiming at the problem of non-uniform high beam brightness in the above solution, the disclosure patent with the application date of Mar. 13, 2013 and the application number of 201310080226.2 discloses a light module of a lighting device of a motor vehicle, and by changing the refraction direction of a local incident plane of a collimating lens, part of high beam light is irradiated to a position below a low beam light and shade cut-off line, however, due to the special structure of the collimating lens, the area of the incident plane of the lens capable of being utilized by the low beam is reduced, which does not meet the requirement and trend of lens miniaturization are not met, in addition, the above method not only increases the difficulty of lens design, manufacturing and detection, but also prevents the low beam light form irradiating on the collimated incident surface, which cause it to irradiate above the cut-off line of light and dark, and also leads to a decrease in the stability of the lamp unit.

With the improvement of user requirements, besides getting rid of a complex shading plate driving mechanism, the vehicle lamp module overcomes and further needs to provide high and low beam with more uniform brightness.

### SUMMARY

The technical problem to be solved in the first aspect of the present disclosure is to provide a vehicle lamp module, and the vehicle lamp module can weaken the boundary of a light and shade cut-off line of a light distribution pattern of high beam and provide high beam with more uniform brightness.

The technical problem to be solved by in the second aspect of the present disclosure is to provide a vehicle lamp which can weaken the boundary of the light and shade cut-off line of the light distribution pattern of the high beam and provide high beam with more uniform brightness.

In order to achieve the above purposes, the first aspect of the present disclosure provides a vehicle lamp module, which includes a lens, a shading plate with a cut-off line structure at one end, a low beam module and a high beam module. Light emitted by the low beam module is suitable for being intercepted by the shading plate and then emitted to the lens to form a low beam type; light emitted by the high beam module is suitable for being intercepted by the shading plate and then emitted to the lens to form a main high beam type located above a light and shade cut-off line. The vehicle lamp module further includes an auxiliary high beam module, and light emitted by the auxiliary high beam module is suitable for being intercepted by the shading plate and then emitted to the lens to form an auxiliary high beam type located below the light and shade cut-off line.

Preferably, the low beam type, the main high beam type and the auxiliary high beam type are all light distribution patterns with light and shade cut-off lines, and the low beam type, the main high beam type and the auxiliary high beam type generated by the low beam module, the high beam module and the auxiliary high beam module respectively can be combined into a high beam type.

Preferably, the low beam module includes a low beam condensing element and a light source, the high beam module includes a high beam condensing element and a light source, and the auxiliary high beam module includes an auxiliary high beam condensing element and a light source.

Further preferably, the low beam condensing element, the high beam condensing element and the auxiliary high beam condensing element can converge light to the cut-off line structure of the shading plate, and the cut-off line structure of the shading plate is located at the focus area of the lens.

Preferably, the low beam condensing element, the high beam condensing element and the auxiliary high beam condensing element are a low beam reflection cup, a high beam reflection cup and an auxiliary reflection cup respectively, perifocuses of the low beam reflection cup, the high beam reflection cup and the auxiliary reflection cup are each provided with a light source, and apofocuses of the low beam reflection cup, the high beam reflection cup and the auxiliary reflection cup are located at the cut-off line structure of the shading plate.

As a preferable structural form of the present disclosure, the low beam reflection cup and the auxiliary reflection cup are connected to form a hyperboloid reflection cup, and the reflecting surface of the high beam reflection cup and the reflecting surface of the hyperboloid reflection cup are oppositely arranged.

As another preferable structural form of the present disclosure, the reflecting surface of the low beam reflection cup is arranged opposite to the reflecting surface of the high beam reflection cup and the reflecting surface of the auxiliary reflection cup.

As another preferable structural form of the present disclosure, the low beam condensing element is a low beam reflection cup, and the high beam condensing element, the auxiliary high beam condensing element and the shading plate are integrated into a high beam integrated condenser.

Specifically, the high beam integrated condenser is sequentially provided with or integrally formed with a light incident part, a light passing part and a light emergent part, an upper total reflection surface is formed on the upper surface of the light passing part, and a lower total reflection surface is formed on the lower surface of the light passing part; the light emergent part is provided with a first light emergent part and a second light emergent part; and the upper total reflection surface and the second light emergent part intersect to form a cut-off line structure.

Typically, the light incident part of the high beam integrated condenser is provided with a light source, and the cut-off line structure of the high beam integrated condenser is located at the focus of the lens.

The second aspect of the present disclosure further provides a vehicle lamp which includes the vehicle lamp module in any one of the technical solutions in the first aspect.

In the above basic technical solutions, the vehicle lamp module provided by the present disclosure not only can rapidly switch the high beam type and the low beam type, but also is additionally provided with the auxiliary high beam light module to form the auxiliary high beam type located below the light and shade cut-off line. The high beam formed by a vehicle lamp module provided in the prior art has an obvious brightness gradient, and the vehicle lamp module provided by the present disclosure can supplement light to a darker area of the high beam in the prior art through the auxiliary high beam module, so that a high beam type with more uniform brightness can be provided.

Other advantages of the present disclosure and the technical effects of the preferable implementation will be further described in the following Detailed Description of the Embodiments.

### BRIEF DESCRIPTION OF THE DRAWINGS

FIG. 1 is a structural schematic diagram and a low beam path schematic diagram of a first embodiment of a vehicle lamp module provided by the present disclosure;

FIG. 2 is a structural schematic diagram and a high beam path schematic diagram of a first embodiment of a vehicle lamp module provided by the present disclosure;

FIG. 3 is a structural schematic diagram and an auxiliary high beam path schematic diagram of a first embodiment of a vehicle lamp module provided by the present disclosure;

FIG. 4 is a structural schematic diagram and a low beam path schematic diagram of a second embodiment of a vehicle lamp module provided by the present disclosure;

FIG. 5 is a structural schematic diagram and a high beam path schematic diagram of a second embodiment of a vehicle lamp module provided by the present disclosure;

FIG. 6 is a structural schematic diagram and an auxiliary high beam path schematic diagram of a second embodiment of a vehicle lamp module provided by the present disclosure;

FIG. 7 is a structural schematic diagram and a low beam path schematic diagram of a third embodiment of a vehicle lamp module provided by the present disclosure;

FIG. 8 is a structural schematic diagram and a high beam path schematic diagram of a third embodiment of a vehicle lamp module provided by the present disclosure;

FIG. 9 is a partial enlarged view of a position A in FIG. 7;

FIG. 10 is a schematic diagram of a low beam type of a vehicle lamp module provided by the present disclosure;

FIG. 11 is a schematic diagram of a main high beam type of a vehicle lamp module provided by the present disclosure;

FIG. 12 is a schematic diagram of an auxiliary high beam type of a vehicle lamp module provided by the present disclosure;

FIG. 13 is a schematic diagram of a high beam type, formed by activating a high beam module and an auxiliary high beam module, of a vehicle lamp module provided by the present disclosure; and

FIG. 14 is a schematic diagram of a high beam type, formed by activating a low beam module, a high beam module and an auxiliary high beam module, of a vehicle lamp module provided by the present disclosure.

Description of reference signs:

| | |
|---|---|
| 11 low beam condensing element | 12 low beam light source |
| 21 high beam condensing element | 22 high beam light source |
| 23 auxiliary high beam condensing | 24 auxiliary high beam light |
| element | source |
| 3 shading plate | 31 cut-off line structure |
| 4 lens | |
| 5 high beam integrated condenser | 51 total high beam light source |
| 52 light incident part | 53 upper total reflection surface |
| 54 lower total reflection surface | 55 first light emergent part |
| 56 second light emergent part | 57 cut-off line structure |

### DETAILED DESCRIPTION OF THE EMBODIMENTS

The specific implementations of the present disclosure will be described in detail below in conjunction with the accompanying drawings. It should be understood that the specific implementations described herein are only used to illustrate and explain the present disclosure, but not to limit the present disclosure.

In the description of the present disclosure, it should be noted that, unless otherwise expressly specified and defined, the terms “connection” and “arrangement” should be understood in a broad sense, for example, connection may fixed connection, detachable connection, or integrated connection; connection may be direct connection or indirect connection through an intermediate medium, and connection may be the internal communication between two elements or the interaction relationship between the two elements. For those of ordinary skill in the art, the specific meanings of the above terms in the present disclosure may be understood according to specific situations.

First of all, it should be noted that, in the description of the following technical solutions of the present disclosure, the orientation terms are defined with the vehicle lamp module itself as the orientation reference, wherein, in the exit direction of the light path, the end where the lens 4 is located is the front, and the opposite end is the rear, the “upper” and “lower” refer to the upper and lower orientations of the lamp module. However, in the actual installation situation, due to the different arrangement positions of the vehicle lamp module in the vehicle, there are various possibilities of orientation arrangement, the orientation terms should be explained according to the actual installation state and in combination with the vehicle lamp module itself as the reference. The defining of the orientation of the vehicle lamp module does not constitute a limitation on the protection scope of the present disclosure.

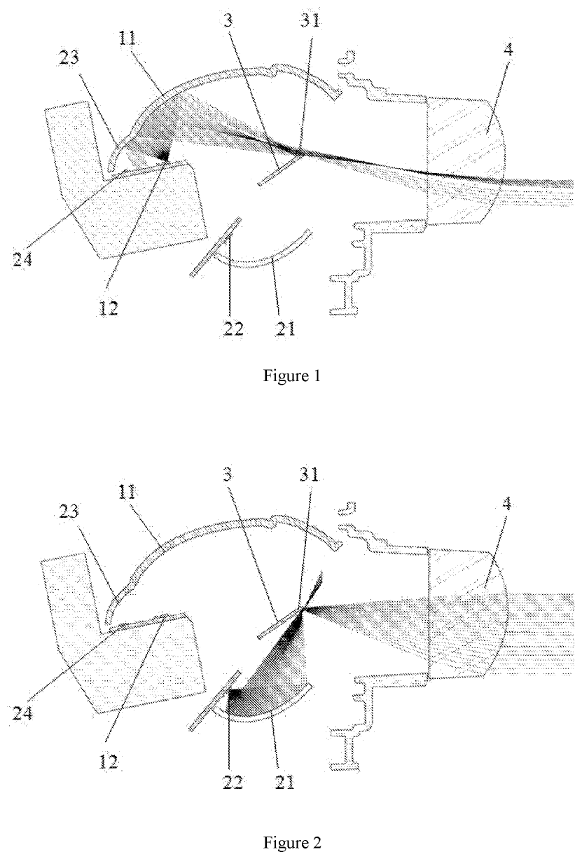

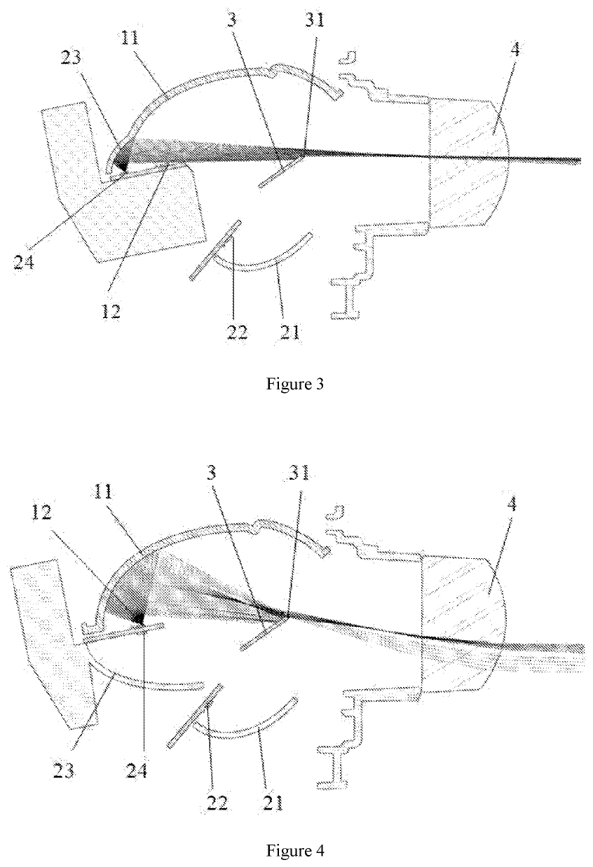

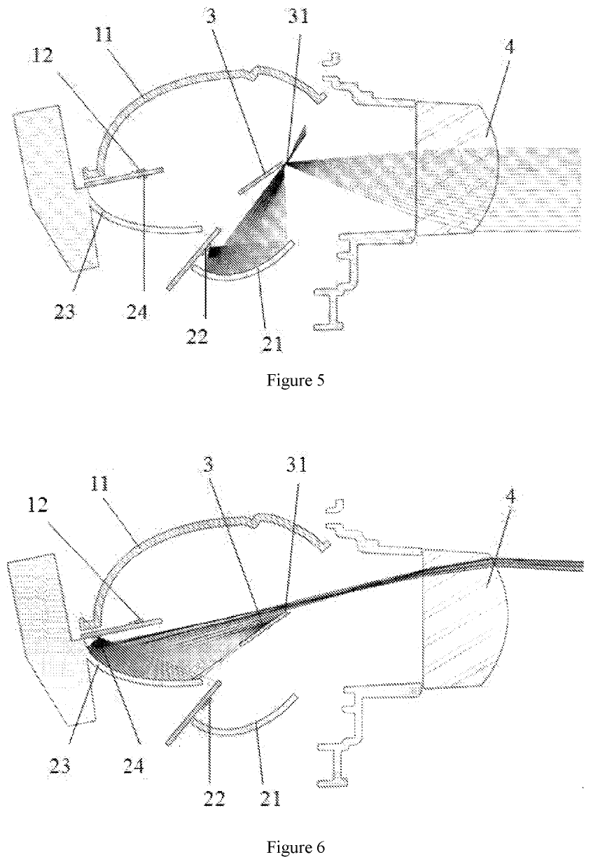

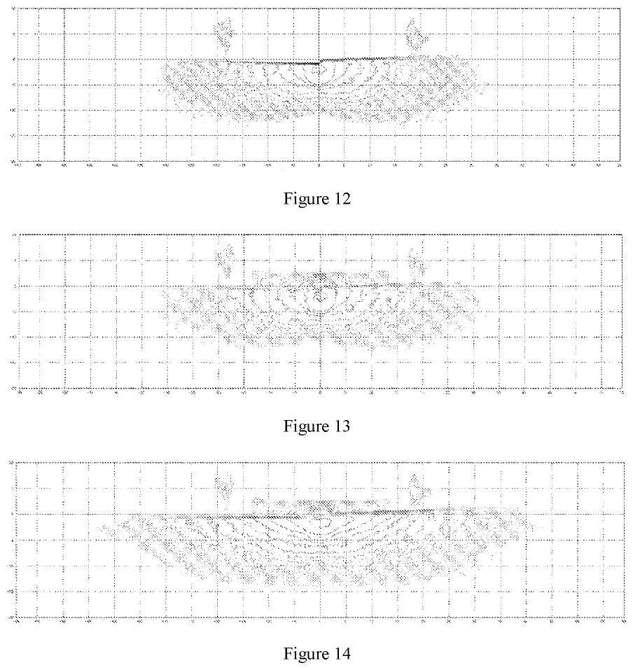

Referring to FIG. 1 to FIG. 8, a vehicle lamp module according to a basic implementation of the present disclosure includes a lens 4, a shading plate 3 with a cut-off line structure 31 at one end, a low beam module and a high beam module, wherein light emitted by the low beam module is intercepted by the cut-off line structure 31 of the shading plate 3 and then emitted to the lens 4 to form a low beam type shown in FIG. 10. Light emitted by the high beam module is intercepted by the cut-off line structure 31 of the shading plate 3 and then emitted to the lens 4 to form a main high beam type located above a light and shade cut-off line and as shown in FIG. 11. The vehicle lamp module further includes an auxiliary high beam module, and light emitted by the auxiliary high beam module is intercepted by the cut-off line structure 31 of the shading plate 3 and then emitted to the lens 4 to form an auxiliary high beam type located below the light and shade cut-off line and as shown in FIG. 12.

An existing vehicle lamp module can also switch high beam and low beam, but the formed high beam type has obvious defects, the brightness of the high beam above a light and shade cut-off line is higher than the brightness of the high beam below the light and shade cut-off line, a part below the light and shade cut-off line forms a dark area where the high beam is distributed, and the high beam type generates a brightness gradient in the shape of the light and shade cut-off line, so that not only is the road surface lighting effect of high beam affected, but also certain potential safety hazards exist; the vehicle lamp module improves the prior art to a certain degree, part of high beam or low beam light is refracted or reflected to be guided to the position below a light and shade cut-off line so as to supplement light to the dark area of the high beam, however, it is difficult to adjust light by using the method, and the manufacturing difficulty of part of optical elements in the vehicle lamp module is increased.

The vehicle lamp module provided by the present disclosure is provided with the low beam module, the high beam module and the auxiliary high beam module, when the low beam module is activated, low beam light emitted by the low beam module is emitted to the shading plate 3, part of the low beam light is shielded by the shading plate 3, and part of the low beam light is emitted from the cut-off line structure 31 of the shading plate 3 and then refracted by the lens 4 to form a low beam type located below the light and shade cut-off line; when the high beam module is activated, high beam light emitted by the high beam module is reflected by the shading plate 3 and then refracted by the lens 4 to form a main high beam type located above the light and shade cut-off line, and the brightness of the main high beam is higher than that of the low beam; when the auxiliary high beam module is activated, light emitted by the auxiliary high beam module is emitted to the shading plate 3, part of the light is shielded by the shading plate 3, another part of the light is emitted from the cut-off line structure 31 of the shading plate 3 and then refracted by the lens 4 to form an auxiliary high beam type located below the light and shade cut-off line, and the auxiliary high beam type can supplement light to a dark area where the high beam is distributed and improve the brightness of high beam and the uniformity of the brightness of the high beam.

Referring to FIG. 10 to FIG. 14, the low beam type, the main high beam type and the auxiliary high beam type are all light distribution patterns with light and shade cut-off lines, the light distribution pattern of the auxiliary high beam is matched with the shape of a dark area in the light distribution pattern of the conventional high beam, and the auxiliary high beam type, the low beam type and the main high beam type can be combined into high beam with uniform brightness.

Specifically, the low beam module includes a low beam condensing element 11 and a light source, the high beam module includes a high beam condensing element 21 and a light source, and the auxiliary high beam module includes an auxiliary high beam condensing element 23 and a light source, wherein an LED light-emitting chip, an OLED light-emitting chip or a light-emitting chip based on a laser light source may be adopted as the light source; ellipsoidal or paraboloid reflection cups may be adopted as the low beam condensing element 11, the high beam condensing element 21 and the auxiliary high beam condensing element 23, or a condenser may also be adopted to play a role in condensing light.

Preferably, most of light emitted by the light source is converged to the cut-off line structure 31 of the shading plate 3 or near the cut-off line structure 31 by the low beam light condensing element 11, the high beam light condensing element 21 and the auxiliary high beam light condensing element 23, and the cut-off line structure 31 of the shading plate 3 is located on a focus of the lens 4 or near the focus. Due to such positioning, the light utilization rate can be improved, and a clearer light distribution pattern can be formed.

Furthermore, the low beam condensing element 11, the high beam condensing element 21 and the auxiliary high beam condensing element 23 are all set as reflection cups which are correspondingly referred to as a low beam reflection cup, a high beam reflection cup and an auxiliary reflection cup respectively, and the reflection cups may be ellipsoidal reflection cups or paraboloid reflection cups. Perifocuses of the low beam reflection cup, the high beam reflection cup and the auxiliary reflection cup are respectively provided with a low beam light source 12, a high beam light source 22 and an auxiliary high beam light source 24, apofocuses of the reflection cups fall on the cut-off line structure 31 of the shading plate 3, and it should be understood that the reflection cup has two focuses, the perifocus is a light incident point, and the apofocus is a light emergent point. Due to such arrangement of the relative positions of the low beam reflection cup, the high beam reflection cup, the auxiliary reflection cup, the shading plate 3 and the lens 4, the light utilization rate can be increased, and the formed light type is clearer.

As a specific structural form, referring to FIG. 1 to FIG. 3, the low beam reflection cup and the auxiliary reflection cup are assembled and connected or integrally formed to form a hyperboloid reflection cup, and the reflecting surface of the high beam reflection cup is opposite to the reflecting surface of the hyperboloid reflection cup. It needs to be noted that the reflecting surface of the high beam reflection cup being opposite to the reflecting surface of the hyperboloid reflection cup is not limited to the placement manner that the two reflecting surfaces are completely opposite, and as long as the light reflected by the hyperboloid reflection cup can be emitted to the upper surface of the shading plate 3, and the light reflected by the high beam reflection cup can be emitted to the lower surface of the shading plate 3, the reflecting surface of the hyperboloid reflection cup and the reflecting surface of the high beam reflection cup can be considered to be in an opposite arrangement state. According to the structure, the low beam reflection cup and the auxiliary reflection cup are integrated into the hyperboloid reflection cup, so that the number of optical elements of the vehicle lamp module is reduced; the hyperboloid reflection cup can be integrally formed, so that the production efficiency is improved, the production cost is reduced, and the light adjusting difficulty is reduced.

As another specific structural form, referring to FIG. 4 to FIG. 6, the reflecting surface of the low beam reflection cup is arranged opposite to the reflecting surface of the high beam reflection cup and the reflecting surface of the auxiliary reflection cup. Under such structural form, the radial size of the vehicle lamp module can be reduced.

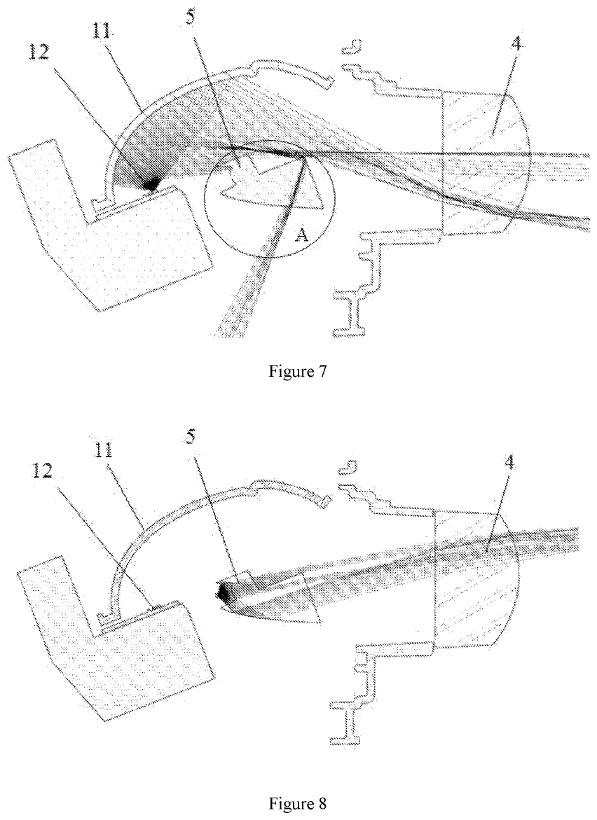

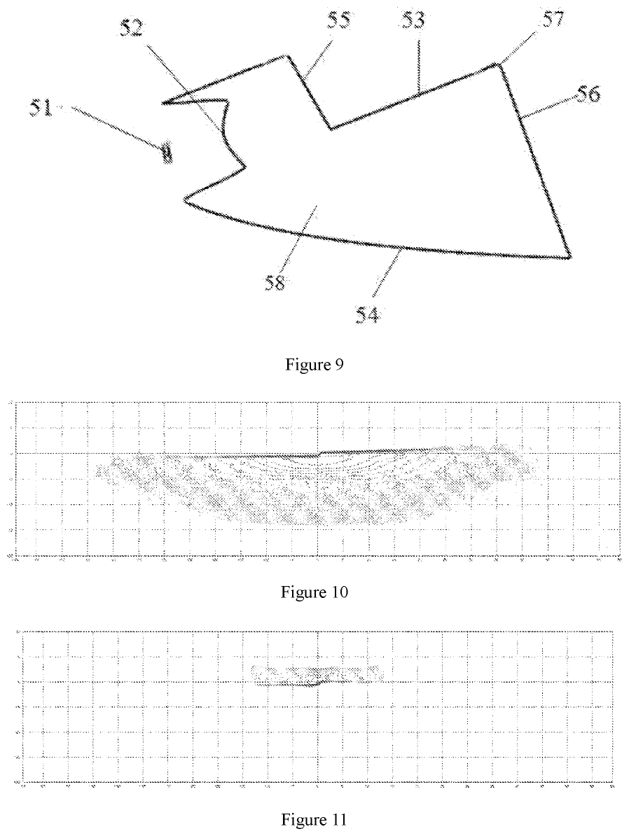

As another specific structural form, referring to FIG. 7 to FIG. 9, the low beam condensing element 11 is a low beam reflection cup, and the high beam condensing element 21, the auxiliary high beam condensing element 23 and the shading plate 3 are integrated into a high beam integrated condenser 5, so that the size of the vehicle lamp module and the number of optical elements in the vehicle lamp module can be reduced; the high beam integrated condenser 5 can be integrally formed, so that the production efficiency is improved, and the production cost is reduced; the multiple optical elements are integrated into one optical element without adjusting the relative positions of the high beam condensing element 21, the auxiliary high beam condensing element 23 and the shading plate 3 in the vehicle lamp module, so that the assembling difficulty and the light adjusting difficulty of the vehicle lamp module are further reduced.

Specifically, the high beam integrated condenser 5 is a transparent solid light conductor, and the high beam integrated condenser 5 is sequentially provided with or integrally formed with a light incident part 52, a light passing part and a light emergent part. Wherein the light incident part 52 is provided with a groove and a light incident surface protruding backwards, and the total high beam light source 51 is placed in the groove, due to the adoption of such a structure, light emitted by the total high beam light source 51 can be well collected, and the utilization rate of the light source can be improved; an upper total reflection surface 53 is formed on the upper surface of the light passing part, a lower total reflection surface 54 protruding outwards is formed on the lower surface of the light passing part, and light can be converged to the area of a cut-off line structure 57 of the high beam integrated condenser 5 after being reflected by the upper total reflection surface 53 and the lower total reflection surface 54; the light emergent part is provided with a first light emergent part 55 and a second light emergent part 56, light used for forming auxiliary high beam is emitted from the first light emergent part 55, and light used for forming main high beam is emitted from the second light emergent part 56; and the upper total reflection surface 53 and the second light emergent part 56 intersect to form the cut-off line structure 57. The relative position of the low beam reflection cup relative to the high beam integrated condenser 5 is adjusted, so that the apofocus of the low beam reflection cup is located on the cut-off line structure 57 of the high beam integrated condenser 5 or in the area nearby the cut-off line structure 57, and light converged by the low beam reflection cup is emitted to the cut-off line structure 57, intercepted by the cut-off line structure 57 and then refracted by the lens 4 to form a low beam type, and light emitted from the first light emergent part 55 and the second light emergent part 56 is intercepted by the cut-off line structure 57 and then refracted by the lens 4 to form an auxiliary high beam type and a main high beam type respectively.

Preferably, the cut-off line structure 57 of the high beam integrated condenser 5 is located at the focus of the lens 4 so as to form a clearer light type, and certainly, the cut-off line structure 57 may also be located near the focus of the lens 4.

Referring to FIG. 1 to FIG. 3, the vehicle lamp module according to a preferable implementation of the present disclosure includes three ellipsoidal reflection cups, namely a low beam reflection cup, a high beam reflection cup and an auxiliary high beam reflection cup; the perifocuses of the low beam reflection cup, the high beam reflection cup and the auxiliary high beam reflection cup are respectively provided with a low beam light source 12, a high beam light source 22 and an auxiliary high beam light source 24, the apofocuses of the low beam reflection cup, the high beam reflection cup and the auxiliary high beam reflection cup all fall into the area of the cut-off line structure 31 of the shading plate 3, and the focus of the lens 4 is located near the cut-off line structure 31 of the shading plate 3, wherein the low beam reflection cup and the auxiliary high beam cup may be integrally formed into a hyperboloid reflection cup. In the structure, when the low beam light source 12 is activated, low beam light emitted by the low beam light source 12 is emitted to the shading plate 3, a small part of the light is reflected by the upper reflecting surface of the shading plate 3, and most of the light is emitted from the cut-off line structure 31 of the shading plate 3 and then refracted by the lens 4 to form a low beam type located below a light and shade cut-off line; when the high beam light source 22 is activated, high beam light emitted by the high beam light source 22 is reflected to the lens 4 by the lower reflecting surface of the shading plate 3 and then refracted by the lens 4 to form a main high beam type located above the light and shade cut-off line, and the brightness of the main high beam is higher than that of the low beam; when the auxiliary high beam light source 24 is activated, light emitted by the auxiliary high beam light source 24 is emitted to the shading plate 3, part of the light is reflected by the upper reflecting surface of the shading plate 3, and another part of the light is emitted from the cut-off line structure 31 of the shading plate 3 and then refracted by the lens 4 to form an auxiliary high beam type located below the light and shade cut-off line. The auxiliary high beam below the light and shade cut-off line is superposed with the low beam and combined with the main high beam above the light and shade cut-off line to form the high beam, referring to FIG. 10 to FIG. 14, so that in the vehicle lamp module provided by the present disclosure, the auxiliary high beam is used for supplementing light to the dark area of the high beam below the light and shade cut-off line so as to provide the high beam with higher and more uniform brightness; and the brightness of the high beam formed by superposition can be more uniform by adjusting the brightness of the low beam light source 12, the high beam light source 22 or the auxiliary high beam light source 24, and the light adjusting method is simple.

Referring to FIG. 7 to FIG. 9, the vehicle lamp module according to another preferable implementation of the present disclosure includes a low beam reflection cup and a high beam integrated condenser 5, the perifocus of the low beam reflection cup is provided with a low beam light source 12, and the apofocus of the low beam reflection cup falls on the cut-off line structure 57 of the high beam integrated condenser 5 or falls near the cut-off line structure 57; a total high beam light source 51 is arranged in a groove of a light incident part 52 of the high beam integrated condenser 5, and the cut-off line structure 57 coincides with the focus of the lens 4 or is located near the focus of the lens 4. When low beam is started, the low beam light source 12 is activated, light converged by the low beam reflection cup is emitted to the cut-off line structure 57, part of the light is emitted to an upper total reflection surface 53 of a light passing part of the high beam integrated condenser 5 and then refracted downwards, and another part of the light is directly emitted to the lens 4 to form a low beam type; the total high beam light source 51 is activated, light emitted by the total high beam light source 51 is reflected by the upper total reflection surface 53 and a lower total reflection surface 54 of the light passing part, then emitted from the first light emergent part 55 and the second light emergent part 56 and converged near the cut-off line structure 57 of the high beam integrated condenser 5, and the light emitted from the first light emergent part 55 forms an auxiliary high beam type below the light and shade cut-off line, the light emitted from the second light emergent part 56 forms a main high beam type above the light and shade cut-off line, and high beam with uniform brightness can be formed by superposition by activating the low beam light source 12 and the total high beam light source 51 at the same time. By means of the structure, the number of optical elements in the vehicle lamp module is further reduced, the size of the vehicle lamp module is reduced, and the high beam integrated condenser 5 is used for replacing the high beam condensing element 21, the auxiliary high beam condensing element 24 and the shading plate 3, so that the light adjusting difficulty of the vehicle lamp module is reduced, and the assembling speed of the vehicle lamp module is increased.

A vehicle lamp provided by the present disclosure includes the optical module in the above technical solution, and adopts all the technical solutions of all the embodiments, and therefore the vehicle lamp at least has all the beneficial effects brought by the technical solutions of the embodiments.

The preferred embodiments of the present disclosure have been described above in detail in conjunction with the accompanying drawings, however, the present disclosure is not limited thereto. Within the scope of the technical concept of the present disclosure, various simple modifications may be made to the technical solutions of the present disclosure, including the combination of various specific technical features in any suitable manner. In order to avoid unnecessary repetition, the present disclosure will not describe various possible combinations. However, these simple modifications and combinations should also be regarded as the content disclosed by the present disclosure, and all belong to the protection scope of the present disclosure.

1. A vehicle lamp module, comprising a lens, a shading plate with a cut-off line structure at one end, a low beam module and a high beam module, light emitted by the low beam module being suitable for being intercepted by the shading plate and then emitted to the lens to form a low beam type, and light emitted by the high beam module being suitable for being intercepted by the shading plate and then emitted to the lens to form a main high beam type located above a light and shade cut-off line, wherein the vehicle lamp module further comprises an auxiliary high beam module, wherein light emitted by the auxiliary high beam module is suitable for being intercepted by the shading plate and then emitted to the lens to form an auxiliary high beam type located below the light and shade cut-off line.

2. The vehicle lamp module according to claim 1, wherein the low beam type, the main high beam type and the auxiliary high beam type are all light distribution patterns with light and shade cut-off lines, and the low beam type, the main high beam type and the auxiliary high beam type generated by the low beam module, the high beam module and the auxiliary high beam module respectively can be combined into a high beam type.

3. The vehicle lamp module according to claim 2, wherein the low beam module comprises a low beam condensing element and a light source, the high beam module comprises a high beam condensing element and a light source, and the auxiliary high beam module comprises an auxiliary high beam condensing element and a light source.

4. The vehicle lamp module according to claim 3, wherein the low beam condensing element, the high beam condensing element and the auxiliary high beam condensing element can converge light to the cut-off line structure of the shading plate, and the cut-off line structure of the shading plate is located at a focus area of the lens.

5. The vehicle lamp module according to claim 4, wherein the low beam condensing element, the high beam condensing element and the auxiliary high beam condensing element are a low beam reflection cup, a high beam reflection cup and an auxiliary reflection cup respectively; perifocuses of the low beam reflection cup, the high beam reflection cup and the auxiliary reflection cup are each provided with a light source; and apofocuses of the low beam reflection cup, the high beam reflection cup and the auxiliary reflection cup are all located at the cut-off line structure of the shading plate.

6. The vehicle lamp module according to claim 5, wherein the low beam reflection cup and the auxiliary reflection cup are connected to form a hyperboloid reflection cup, and a reflecting surface of the high beam reflection cup and a reflecting surface of the hyperboloid reflection cup are oppositely arranged.

7. The vehicle lamp module according to claim 5, wherein a reflecting surface of the low beam reflection cup is arranged opposite to the reflecting surface of the high beam reflection cup and the reflecting surface of the auxiliary reflection cup.

8. The vehicle lamp module according to claim 3, wherein the low beam condensing element is a low beam reflection cup, and the high beam condensing element, the auxiliary high beam condensing element and the shading plate are integrated into a high beam integrated condenser.

9. The vehicle lamp module according to claim 8, wherein the high beam integrated condenser is sequentially provided with or integrally formed with a light incident part, a light passing part and a light emergent part, an upper total reflection surface is formed on an upper surface of the light passing part, and a lower total reflection surface is formed on a lower surface of the light passing part; the light emergent part is provided with a first light emergent part and a second light emergent part; and the upper total reflection surface and the second light emergent part intersect to form a cut-off line structure.

10. The vehicle lamp module according to claim 9, wherein the light incident part of the high beam integrated condenser is provided with a light source, and the cut-off line structure of the high beam integrated condenser is located at the focus of the lens.

11. A vehicle lamp, comprising the vehicle lamp module according to claim 1.

12. The vehicle lamp according to claim 11, wherein the low beam type, the main high beam type and the auxiliary high beam type are all light distribution patterns with light and shade cut-off lines, and the low beam type, the main high beam type and the auxiliary high beam type generated by the low beam module, the high beam module and the auxiliary high beam module respectively can be combined into a high beam type.

13. The vehicle lamp according to claim 12, wherein the low beam module comprises a low beam condensing element and a light source, the high beam module comprises a high beam condensing element and a light source, and the auxiliary high beam module comprises an auxiliary high beam condensing element and a light source.

14. The vehicle lamp according to claim 13, wherein the low beam condensing element, the high beam condensing element and the auxiliary high beam condensing element can converge light to the cut-off line structure of the shading plate, and the cut-off line structure of the shading plate is located at a focus area of the lens.

15. The vehicle lamp according to claim 14, wherein the low beam condensing element, the high beam condensing element and the auxiliary high beam condensing element are a low beam reflection cup, a high beam reflection cup and an auxiliary reflection cup respectively; perifocuses of the low beam reflection cup, the high beam reflection cup and the auxiliary reflection cup are each provided with a light source; and apofocuses of the low beam reflection cup, the high beam reflection cup and the auxiliary reflection cup are all located at the cut-off line structure of the shading plate.

16. The vehicle lamp according to claim 15, wherein the low beam reflection cup and the auxiliary reflection cup are connected to form a hyperboloid reflection cup, and a reflecting surface of the high beam reflection cup and a reflecting surface of the hyperboloid reflection cup are oppositely arranged.

17. The vehicle lamp according to claim 15, wherein a reflecting surface of the low beam reflection cup is arranged opposite to the reflecting surface of the high beam reflection cup and the reflecting surface of the auxiliary reflection cup.

18. The vehicle lamp according to claim 13, wherein the low beam condensing element is a low beam reflection cup, and the high beam condensing element, the auxiliary high beam condensing element and the shading plate are integrated into a high beam integrated condenser.

19. The vehicle lamp according to claim 18, wherein the high beam integrated condenser is sequentially provided with or integrally formed with a light incident part, a light passing part and a light emergent part, an upper total reflection surface is formed on an upper surface of the light passing part, and a lower total reflection surface is formed on a lower surface of the light passing part; the light emergent part is provided with a first light emergent part and a second light emergent part; and the upper total reflection surface and the second light emergent part intersect to form a cut-off line structure.

20. The vehicle lamp according to claim 19, wherein the light incident part of the high beam integrated condenser is provided with a light source, and the cut-off line structure of the high beam integrated condenser is located at the focus of the lens.
